(19) United States
(12) Patent Application Publication
(10) Pub. No.: US 2022/0206204 A1
(43) Pub. Date: Jun. 30, 2022

(54) POLARIZING LAMINATE AND IMAGE DISPLAY DEVICE INCLUDING THE SAME

(71) Applicant: DONGWOO FINE-CHEM CO., LTD., Jeollabuk-do (KR)

(72) Inventors: Jeong Eun LEE, Gyeonggi-do (KR); Min Seok KIM, Gyeonggi-do (KR)

(21) Appl. No.: 17/563,476

(22) Filed: Dec. 28, 2021

(30) Foreign Application Priority Data
Dec. 29, 2020 (KR) 10-2020-0185869

(51) Int. Cl. G02B 5/30

(52) U.S. Cl. CPC G02B 5/3083; G02B 5/305

(57) ABSTRACT

A polarizing laminate according to an embodiment of the present invention includes a first adhesive layer, a polarizer disposed on an upper surface of the first adhesive layer, and a first retardation layer disposed on a lower surface of the first adhesive layer. The polarizing layer has a refractive index smaller than that of the first adhesive layer, and the first retardation layer has a refractive index greater than that of the first adhesive layer. The polarizing laminate has improved anti-reflective properties to front and oblique directions.

### CROSS-REFERENCE TO RELATED APPLICATION AND CLAIM OF PRIORITY

This application claims priority to Korean Patent Application No. 10-2020-0185869 filed on Dec. 29, 2020 in the Korean Intellectual Property Office (KIPO), the entire disclosures of which are incorporated by reference herein.

### BACKGROUND

### 1. Field

The present invention relates to a polarizing laminate and an image display device including the same. More particularly, the present invention relates to a polarizing laminate including a polarizer and a retardation film and an image display device including the same

### 2. Description of the Related Art

As information technologies are being developed, various demands in display devices having thinner dimension, light-weight, high efficiency in power consumption, etc., are increasing. The display device may include a flat panel display device such as a liquid crystal display (LCD) device, a plasma display panel (PDP) device, an electro-luminescent display device, an organic light emitting diode (OLED) display device, etc.

When an external light is incident on the display device, the external light may be reflected or scattered on a display surface of the display device to cause degradation of an image quality from the display device. Thus, an optical film including a retardation film and a polarizer may be combined with the display device to improve the image quality.

As various functions are added to the display device, a laminated structure of the optical film may become more complicated. In this case, a reflection and scattering of light may occur at an interface in the optical film, and the image quality may be deteriorated by the reflection and scattering of the external light or a light emitted from an inside of the display device.

For example, Korean Published Patent Application No. 10-2013-0110204 discloses a polarizing plate for realizing a high-contrast image, which may not sufficiently resolve the image quality degradation due to the light reflection and the light scattering.

### SUMMARY

According to an aspect of the present invention, there is provided a polarizing laminate having improved optical property.

According to an aspect of the present invention, there is provided an image display device having improved optical property.

(1) A polarizing laminate, including: a first adhesive layer; a polarizer disposed on an upper surface of the first adhesive layer, the polarizer having a refractive index smaller than that of the first adhesive layer; and a first retardation layer disposed on a lower surface of the first adhesive layer, the first retardation layer having a refractive index greater than that of the first adhesive layer.

(2) The polarizing laminate of the above (1), wherein the first retardation layer includes a quarter-wave retardation film or a half-wave retardation film.

(3) The polarizing laminate of the above (1), wherein the refractive index of the polarizer is from 1.47 to 1.51.

(4) The polarizing laminate of the above (1), wherein the refractive index of the first adhesive layer is from 1.51 to 1.57.

(5) The polarizing laminate of the above (1), wherein the refractive index of the first retardation layer is from 1.55 to 1.61.

(6) The polarizing laminate of the above (1), further including a second retardation layer disposed under the first retardation layer, and a difference of refractive indices between the first retardation layer and the second retardation layer is 0.05 or less.

(7) The polarizing laminate of the above (6), further including a second adhesive layer disposed between the first retardation layer and the second retardation layer, and a difference of refractive indices between the second adhesive layer and the first retardation layer, and a difference of refractive indices between the second adhesive layer and of the second retardation layer are each 0.05 or less.

(8) The polarizing laminate of the above (1), further including a lower adhesive layer disposed under the first retardation layer.

(9) The polarizing laminate of the above (8), wherein a difference of refractive indices between the lower adhesive layer and the first retardation layer is 0.05 or less.

(10) The polarizing laminate of the above (1), further including a polarizer protective layer disposed on a top surface of the polarizer.

(11) An image display device, including: a display panel; and the polarizing laminate according to embodiments as described above on the display panel.

(12) The image display device of the above (11), further including a touch sensor layer disposed on the polarizing laminate or disposed between the display panel and the polarizing laminate.

(13) The image display device of the above (11), wherein the image display device is a flexible display.

According to embodiments of the present invention, in a polarizing laminate in which a polarizer, a first adhesive layer and a first retardation layer are sequentially stacked, a refractive index of each layer may be sequentially increased. Accordingly, an interlayer reflection may be suppressed by a refractive index matching between adjacent layers. Thus, anti-reflection properties in a front direction and an oblique direction may be improved.

In some embodiments, a second adhesive layer, a second retardation layer and/or a lower adhesive layer which may have a refractive index smaller than that of the first retardation layer may be interposed on a bottom surface of the first retardation layer, so that the anti-reflection properties may be further improved.

### BRIEF DESCRIPTION OF THE DRAWINGS

FIGS. 1 and 2 are schematic cross-sectional views illustrating polarizing laminates in accordance with exemplary embodiments.

FIG. 3 is a schematic cross-sectional view illustrating an image display device in accordance with exemplary embodiments.

### DETAILED DESCRIPTION

According to exemplary embodiments of the present invention, there is provided a polarizing laminate including a polarizer, an adhesive layer and a retardation layer sequentially stacked. An image display device including the polarizing laminate is also provided.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “upper”, “lower”, “top”, “bottom”, etc., used herein do not designate an absolute position, but are relatively used to distinguish different elements or different positions.

The term “adhesive” herein is used to include both a pressure sensitive adhesive (PSA), and a bond or a glue.

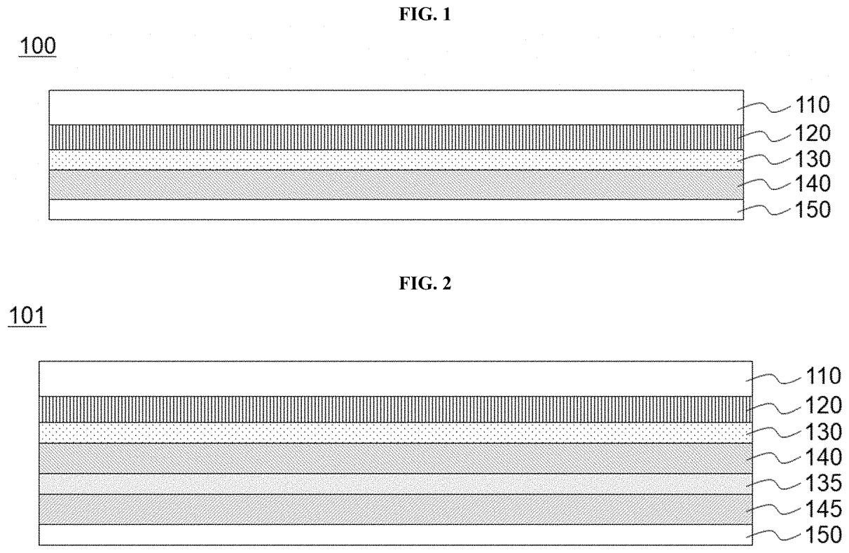

FIG. 1 is a schematic cross-sectional view illustrating a polarizing laminates in accordance with exemplary embodiments.

Referring to FIG. 1, a polarizing laminate 100 may include a polarizer 120, a first adhesive layer 130 and a first retardation layer 140. The polarizing laminate 100 may further include a polarizer protective layer 110 and/or a lower adhesive layer 150.

The polarizer 120 may be, e.g., a film in which a dichroic dye is adsorbed and oriented in a stretched polyvinyl alcohol-based resin film. The polyvinyl alcohol-based resin may be obtained by saponifying a polyvinyl acetate-based resin.

Examples of the polyvinyl acetate-based resin include polyvinyl acetate that is a homopolymer of vinyl acetate, or a copolymer of vinyl acetate and other monomers co-polymerizable therewith. Examples of other monomers co-polymerizable with vinyl acetate include unsaturated a carboxylic acid-based monomer, a unsaturated sulfonic acid-based monomer, an olefin-based monomer, a vinyl ether-based monomer, an acrylamide-based monomer having an ammonium group, etc.

The polyvinyl alcohol-based resin may be modified. For example, polyvinyl formal or polyvinyl acetal which may be modified with an aldehyde may be used. A degree of saponification of the polyvinyl alcohol-based resin may be from 85 mol % to 100 mol %, preferably 98 mol % or more. A degree of polymerization of the polyvinyl alcohol-based resin may be about 1,000 to 10,000, preferably from 1,500 to 5,000.

The above-described polyvinyl alcohol-based resin film may be used as a raw film of the polarizer 120. A thickness of the raw film may be, e.g., from 10 μm to 150 μm.

In some embodiments, the polarizer 120 may be fabricated by uniaxially stretching a polyvinyl alcohol-based film, dyeing with a dichroic dye and adsorbing the dichroic dye, treating with an aqueous boric acid solution, washing with water, drying process, etc.

In example embodiments, a refractive index of the polarizer 120 may be from 1.47 to 1.51. The refractive index range may be achieved according to the above-described process of the fabrication of the polarizer 120.

In exemplary embodiments, a thickness of the polarizer 120 may be preferably from 3 μm to 20 μm, more preferably from 5 μm to 18 μm, even more preferably from 8 μm to 15 μm. In the above range, an entire thickness of the polarizing laminate may be reduced.

The first adhesive layer 130 may be disposed on one surface of the polarizer 120. For example, the first adhesive layer 130 may be directly formed on a bottom surface of the polarizer 120.

A refractive index of the first adhesive layer 130 may be greater than that of the polarizer 120. In this case, a reflection or scattering of light at an interface between the polarizer 120 and the first adhesive layer 130 may be suppressed.

In exemplary embodiments, the refractive index of the first adhesive layer 130 may be from 1.51 to 1.57.

In exemplary embodiments, the first adhesive layer 130 may include a photocurable adhesive. The photocurable adhesive may be cured by an energy ray (e.g., an ultraviolet ray).

In some embodiments, the polarizer protective layer 110 may be attached to the polarizer 120 using an adhesive.

For example, the adhesive may include a photocurable adhesive composition. The photocurable adhesive composition may be coated on an attachment surface of the polarizer 120 or the polarizer protective layer 110, and the polarizer 120 or the polarizer protective layer 110 may be coupled to each other. Thereafter, the adhesive composition may be cured and crosslinked through an exposure process so that the polarizer 120 and the polarizer protective layer 110 may be attached.

The photocurable adhesive composition may include a photopolymerizable compound, a photo-initiator, a photosensitizer and/or a solvent.

The photopolymerizable compound may include a photoradically polymerizable compound or a photocationically polymerizable compound. Preferably, the photoradically polymerizable compound or the photocationically polymerizable compound may be used together.

In exemplary embodiments, the photopolymerizable compound may include an alicyclic epoxy resin having two or more epoxy groups in a molecule and at least one of the epoxy groups being an alicyclic epoxy group.

The alicyclic epoxy resin may include, e.g., a widely-known epoxy compound. An adhesive strength of an adhesive layer may be increased by the alicyclic epoxy resin.

Preferably, the alicyclic epoxy resin may have two epoxy groups in the molecule, and both of the two epoxy groups may be alicyclic epoxy groups.

The number of carbon atoms of an alicyclic ring in the alicyclic epoxy group may be from 5 to 7. Preferably, the alicyclic ring may be an epoxycyclohexyl group having a cyclohexane ring having 6 carbon atoms.

The alicyclic epoxy resin may include, e.g., a compound represented by the following Chemical Formula 1 below.

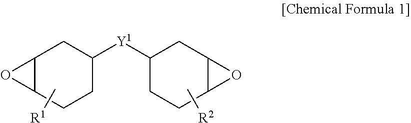

In Chemical Formula 1, R¹ and R² may each be independently an alkyl group having 1 to 12 carbon atoms, Y¹ may be an alkylene group having 1 to 12 carbon atoms, and the alkylene group may be substituted with an ether group (—O—), an ester group (—COO—) an amide group (—CONR—), or the like.

If the carbon number of R¹ and R² is 12 or less, curing rate and adhesive strength may be improved.

In exemplary embodiments, the photopolymerizable compound may further include a non-alicyclic epoxy resin having two or more epoxy groups in the molecule and not having an alicyclic epoxy group. The said non-alicyclic epoxy resin may improve flexibility of the adhesive layer after being cured.

The non-alicyclic epoxy resin may be, e.g., a bisphenol-type epoxy resin, a novolak-type epoxy resin, an aromatic epoxy resin, a glycidyl ether-based or a poly glycidyl ether-based compound, a polymer of glycidyl (meth)acrylate, an epoxidized vegetable oil and derivatives thereof, epoxidized polybutadiene, etc.

The photopolymerization initiator may include, e.g., a photoradically polymerization initiator such as an acetophenone-based initiator, a benzophenone-based initiator, a thioxanthone-based initiator, a benzoin-based initiator or a benzoin alkyl ether-based initiator and/or a photocationic polymerization initiator such as an aromatic diazonium salt, an aromatic sulfonium salt, an aromatic iodine aluminum salt, a benzoinsulfonic acid ester compound, etc. When the photocationic polymerization initiator is used, deterioration and discoloration of the adhesive and/or an object of the adhesive may be prevented during the curing process of the adhesive.

In exemplary embodiments, the photopolymerization initiator may be included in an amount of 0.5 weight percent (wt %) to 20 wt % by weight based on a total weight of the composition.

The photosensitizer may include, e.g., an anthracene-based compound. For example, the photosensitizer may include a compound represented by Chemical Formula 2 below. In this case, a refractive index of the adhesive layer may be adjusted in a desired range while enhancing an adhesiveness of the adhesive layer.

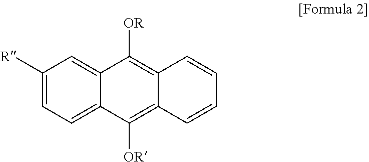

In Formula 2, R and R′ may each independently represent an alkyl group having 1 to 18 carbon atoms or an alkyl group having 2 to 18 carbon atoms containing an ether group, and R″ may be hydrogen or an alkyl group having 1 to 18 carbon atoms.

A primer treatment, a plasma treatment, a corona treatment or a saponification (alkali) surface treatment may be performed on an attachment surface of the polarizer 120 and/or the polarizer protective layer 110 to improve adhesion through the adhesive.

In some embodiments, the polarizer protective layer 110 may be directly formed on one surface of the polarizer 120. In this case, the thickness of the polarizing laminate 100 may be reduced while increasing flexibility.

In some embodiments, a thickness of the polarizer protective layer may be from 10 μm to 50 μm, preferably from 15 μm to 30 μm.

The first retardation layer 140 may face the polarizer 120 with the first adhesive layer 130 interposed therebetween. For example, the first retardation layer 140 may be directly formed on a bottom surface of the first adhesive layer 130. In this case, a polarizer protective film may be omitted between the polarizer 120 and the first retardation layer 140, so that a structure of the polarizing laminate 100 may be simplified and the thickness may be further reduced.

A refractive index of the first retardation layer 140 may be greater than that of the first adhesive layer 130. In this case, a refractive index matching relationship where the refractive index gradually increases in an order of the polarizer 120, the first adhesive layer 130 and the first retardation layer 140 may be formed. The refractive indices at interfaces may be gradually increased, so that a difference in refractive indices between adjacent layers may be reduced even when a plurality of layers are stacked. Accordingly, interfacial reflection and scattering caused by the difference in refractive index between adjacent layers may be reduced.

In exemplary embodiments, the refractive index of the first retardation layer 140 may be from 1.55 to 1.61.

An incident light to the first retardation layer 140 may be retarded with respect to a component that vibrates in a slow axis direction when being emitted. Accordingly, a reflection of the incident light from an outside may be suppressed.

The term “slow axis” used herein may refer to an optical axis in which a phase delay or a phase difference occurs when a light penetrates a film.

In exemplary embodiments, the first retardation layer 140 may include a quarter-wave retardation film or a half-wave retardation film. For example, the first retardation layer 140 may have a single layer of the quarter-wave retardation film, or a laminate of the quarter-wave retardation film and the half-wave retardation film.

The half-wave retardation film and the quarter-wave retardation film may have a negative wavelength dispersion, a flat wavelength dispersion or a positive wavelength dispersion.

The half-wave retardation film and the quarter-wave retardation film may be formed as a film type or a liquid crystal coating layer.

The film-type retardation film may be obtained by, e.g., orienting a polymer film in a uniaxial direction, a biaxial direction or any suitable method. For example, the polymer film may be a cyclic polymer olefin (COP)-based resin, a polycarbonate-based resin, a polyester-based resin, a polysulfone-based resin, a polyethersulfone-based resin, a polystyrene-based resin, a polyolefin-based resin, a polyvinyl alcohol-based resin, a cellulose acetate-based resin, a polymethyl (meth)acrylate-based resin, a polyvinyl chloride-based resin, a polyacrylate-based resin, a polyamide-based resin, etc.

The liquid crystal coating type retardation film may be prepared using a reactive liquid crystal composition including a nematic or smectic liquid crystal material. For example, the reactive liquid crystal composition may be coated on a substrate, oriented in a planar alignment, and polymerized by an exposure to heat or ultraviolet to obtain the retardation film.

An incident light to half-wave retardation film and the quarter-wave retardation film may be retarded by ½ and ¼, respectively, with respect to a component that vibrates in a slow axis direction when being emitted. Accordingly, a reflection of the incident light from an outside may be effectively suppressed.

For example, a slow axis of the quarter-wave retardation film may form an angle from 40° to 50° (e.g., about 45°) with respect to an absorption axis of the polarizer 120.

Accordingly, a light polarized by the polarizer 120 may be converted into a circularly polarized light. The circularly polarized light may be reflected and a rotation direction may be inverted. The inverted circularly polarized light may be converted into a polarized light having a polarization axis of about 90° with respect to a polarization axis of the incident polarized light while penetrating the quarter-wave retardation film again. The converted polarized light may be blocked by the polarizer 120. Thus, an external light reflection may be suppressed by the polarizing laminate 100.

FIG. 2 is a schematic cross-sectional view illustrating a polarizing laminates in accordance with exemplary embodiments.

Referring to FIG. 2, a polarizing laminate 101 may further include a second adhesive layer 135 and a second retardation layer 145.

In some embodiments, the second adhesive layer 135 and the second retardation layer 145 may be disposed on the other surface of the first retardation layer 140 opposite to one surface of the first retardation layer 140 on which the first adhesive layer 130 is formed.

In exemplary embodiments, the second retardation layer 145 may include the other one of the quarter-wave retardation film and the half-wave retardation film that is not included in the first retardation layer 140.

For example, if the first retardation layer 140 includes the quarter-wave retardation film, the second retardation layer 145 may include the half-wave retardation film. If the first retardation layer 140 includes the half-wave retardation film, the second retardation layer 145 may include the quarter-wave retardation film.

When both the quarter-wave retardation film and the half-wave retardation film retardation film are used, a phase retardation effect may be substantially implemented over an entire visible light region, so that an image display device in which optical defects such as a light-leakage phenomenon are suppressed may be implemented.

In an embodiment, the half-wave retardation film and the quarter-wave retardation film may be sequentially disposed from the polarizer 120.

Preferably, the first retardation layer 140 may include the half-wave retardation film and the second retardation layer 145 may include the quarter-wave retardation film. In this case, a front refection and an oblique reflection may be effectively suppressed.

In exemplary embodiments, a difference between the refractive indices of the second retardation layer 145 and the first retardation layer 140 may be 0.05 or less. In the above range, interfacial reflection and scattering may be more effectively suppressed.

In some embodiments, the refractive index of the second retardation layer 145 may be smaller than that of the first retardation layer 140. In this case, a refractive index gradient in which the refractive index decreases again based on the first retardation layer 140 in a thickness direction of the polarizing laminate 100 may be formed, so that the external light reflection may be effectively suppressed.

In some embodiments, the refractive index of the second retardation layer 145 may be from 1.50 to 1.56.

The second adhesive layer 135 may be interposed between the first retardation layer 140 and the second retardation layer 145. The second adhesive layer 135 may directly contact surfaces of the first retardation layer 140 and the second retardation layer 145. The second adhesive layer 135 may be formed of the above-described photocurable adhesive.

In exemplary embodiments, the refractive index difference between the second adhesive layer 135 and the first retardation layer 140 may be 0.05 or less, and the refractive index difference between the second adhesive layer 135 and the second retardation layer 145 may also be 0.05 or less. In this case, the external light reflection may be more effectively suppressed.

In some embodiments, the refractive index of the second adhesive layer 135 may be between the refractive index of the first retardation layer 140 and the refractive index of the second retardation layer 145. In this case, the refractive indices may be gradually decreased from the first retardation layer 140 to the second retardation layer 145, and the refractive index difference between adjacent layers may be reduced. Additionally, a refractive index gradient in which the refractive index decreases again based on the first retardation layer 140 in the thickness direction of the polarizing laminate 100 may be created.

In some embodiments, the refractive index of the second adhesive layer 135 may be from 1.51 to 1.57.

In exemplary embodiments, the polarizer protective layer 110 may be disposed on a surface of the polarizer 120 opposite to the surface on which the first adhesive layer 130 is formed. For example, the polarizer protective layer 110 may be directly formed on a top surface of the polarizer 120.

The polarizer protective layer 110 may include a resin film having enhanced transparency, mechanical strength, thermal stability, moisture shielding property, isotropic property, etc. For example, the polarizer protective layer 110 may include an acrylic resin such as polymethyl (meth)acrylate or polyethyl (meth)acrylate; a polyester-based resin such as polyethylene terephthalate, polyethylene isophthalate, polyethylene naphthalate or polybutylene terephthalate; a cellulose resin such as diacetyl cellulose or triacetyl cellulose; a polyolefin-based resin such as polyethylene, polypropylene, a polyolefin resin having a cyclo-based or norbornene structure or an ethylene-propylene copolymer, etc.

A glass transition temperature of the resin included in the polarizer protective layer 110 may be 80° C. or higher, preferably from 100° C. to 250° C.

In exemplary embodiments, a thickness of the polarizer protective layer 110 may be from 10 μm to 50 μm. Within the above range, folding properties of the polarizing laminate 100 may be maintained while achieving mechanical strength for the protection of the polarizer 120.

In some embodiments, an elastic modulus of the polarizer protective layer 110 may be from 1,000 MPa to 7,000 MPa, preferably from 1,500 MPa to 5,000 MPa. Within the above range, the polarizing laminate 100 including the polarizer 120 may be effectively protected from an external impact.

In some embodiments, the polarizing laminate 100 may include an additional protective film on a top surface of the polarizer protective layer 110, and may further include the lower adhesive layer 150 and/or a release film on a bottom surface of the first retardation layer 140 or the second retardation layer 145. The additional protective film and the release film may protect the polarizing laminate 100 in a distribution process, and may be removed when the polarizing laminate 100 is applied to a product.

In exemplary embodiments, the lower adhesive layer 150 may be formed on a bottom surface of the first retardation layer 140. If the polarizing laminate 100 includes the second retardation layer 145, the lower adhesive layer 150 may be formed on a bottom surface of the second retardation layer 145. The lower adhesive layer 150 may be protected by the release film, and may be attached to another member after removing the release film when employing the polarizing laminate 100 to a product.

In exemplary embodiments, the lower adhesive layer 150 may include a pressure sensitive adhesive.

In exemplary embodiments, a difference between the refractive index of the lower adhesive layer 150 and the refractive index of the first retardation layer 140 or the second retardation layer 145 may be 0.05 or less.

In some embodiments, the refractive index of the lower adhesive layer 150 may be smaller than that of the first retardation layer 140 or the second retardation layer 145.

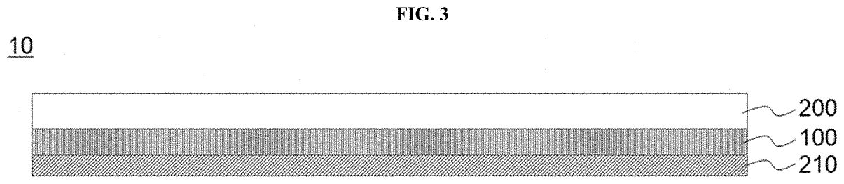

FIG. 3 is a schematic cross-sectional view illustrating an image display device in accordance with exemplary embodiments.

Referring to FIG. 3, an image display device 10 may include the polarization laminate 100, a cover window 200 and a display panel 210. In exemplary embodiments, the image display device may be provided as a flexible display.

The term “viewing side” used herein refers to a surface closer to a user's eye when the polarizing laminate 100 is used in an image display device. For example, an opposite side to the viewer side may face a display panel of the image display device. Hereinafter, the opposite side to the viewer side is referred to as a “panel side”.

The cover window 200 may include as glass or a flexible resin such as polyimide. In an embodiment, the cover window 200 may include a touch sensor. The cover window 200 may be disposed at the viewing side of the image display device 10.

In an embodiment, the touch sensor may be interposed between the polarization laminate 100 and the cover window 200 or between the polarization laminate 100 and the display panel 210 as an independent layer.

The polarizing laminate 100 may be disposed such that the polarizer protective layer 110 may face the viewing side or the cover window 200. The first retardation layer 140 of the polarization laminate 100 may be toward the display panel 210. For example, the release film of the polarizing laminate 100 may be removed and the display panel 210 may be combined using the adhesive layer.

In exemplary embodiments, the display panel 210 may include a liquid crystal display device or an organic light emitting diode (OLED) device, and may be used as a flexible display.

The display panel 210 may include a pixel electrode, a pixel defining layer, a display layer, a counter electrode and an encapsulation layer disposed on a panel substrate.

The panel substrate may include glass or a flexible resin material such as polyimide. A pixel circuit including a thin film transistor (TFT) may be formed on the panel substrate, and an insulating layer covering the pixel circuit may be formed. The pixel electrode may be electrically connected to, e.g., a drain electrode of the TFT on the insulating layer.

The pixel defining layer may be formed on the insulating layer to expose the pixel electrode to define a pixel region. The display layer may be formed on the pixel electrode, and the display layer may include, e.g., an organic light emission layer.

The counter electrode may be disposed on the pixel defining layer and the display layer. The counter electrode may serve, e.g., as a common electrode or a cathode of the image display device. The encapsulation layer for protecting the display panel may be stacked on the counter electrode.

The polarizing laminate 100 according to exemplary embodiments may serve as an upper or lower polarizing plate of a liquid crystal display device or an anti-reflection polarizing plate of an OLED display device.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Example: Preparation of Polarizing Laminate

A transparent, unstretched polyvinyl alcohol film (PE3000, KURARAY) having a saponification degree of 99.9% or more was swelled by immersing in water (deionized water) at 30° C. for 2 minutes, and then dyed by immersing in a dyeing solution that contained iodine 1.25 mM/L, potassium iodide 1.25 wt % and nitric acid 0.0005 wt % at 30° C. for 4 minutes.

Specifically, stretching was performed in the swelling and dyeing steps by a draw ratio of 1.3 and 1.4, respectively, so that a cumulative draw ratio until a dyeing bath was 1.82.

Thereafter, the polyvinyl alcohol film was crosslinked by immersing (a first crosslinking) in an aqueous solution for crosslinking that contained 10 wt % of potassium iodide and 3.7 wt % of boric acid at 50° C. for 30 seconds while stretching by a draw ratio of 2. Then, the film was immersed (a second crosslinking) in an aqueous solution for crosslinking that contained 10 wt % of potassium iodide and 3.7 wt % of boric acid at 50° C. for 20 seconds while crosslinking and stretching by a draw ratio of 1.5 (a cumulative draw ratio of the first and second crosslinking was 3). A total cumulative draw ratio of the swelling, dyeing and crosslinking steps was 5.46. The crosslinked polyvinyl alcohol film was dried in an oven at 70° C. for 4 minutes to prepare a polarizer having a thickness of 8 μm.

A half-wave retardation film (Fujifilm, the λ/2 plate of Example 4 in Korean Published Patent Application No. 10-2014-7025436, material DLC) and a quarter-wave retardation film (Fujifilm, the λ/4 plate of Example 4 of Korean Published Patent Application No. 10-2014-7025436, material RLC) was sequentially attached on a bottom surface of the polarizer using an adhesive. A total thickness of the adhesive, the half-wave retardation film and the quarter-wave retardation film was 7.5 μm.

A cyclic polyolefin-based resin film (Zeon, Zeonor ZD+HC) as a polarizer protective layer was attached on a top surface of the polarizer to obtain a polarizing laminate having a structure of polarizer protective layer/polarizer/first adhesive layer/first retardation layer/second adhesive layer/second retardation layer.

The first adhesive layer and the second adhesive layer were formed by applying adhesive compositions described below to be attached to each layer, and then performing a UV curing with a high-pressure mercury lamp (UVA accumulated light amount of 400 mJ/cm²).

Refractive index of each of the protective layer, the polarizer, the adhesive layer between the polarizer and the half-wave retardation film (the first adhesive layer), the half-wave retardation film, the adhesive layer between the half-wave retardation film and the quarter-wave retardation film (the second adhesive) and the quarter-wave retardation film was measured with ATAGO's Refactometer and as shown in Tables 1 and 2 below (the number in a parentheses is a thickness of each layer).

TABLE 1

| | | Example | Example | Example | Example | Example | Example | Example |
|---|---|---|---|---|---|---|---|---|
| | | 1 | 2 | 3 | 4 | 5 | 6 | 7 |
| Protective | Type | ZD + HC(29 μm) | | | | | | |
| Layer | Refractive | 1.54 | | | | | | |
| | Index | | | | | | | |
| Polarizer | Type | PVA(13 μm) | | | | | | |
| | Refractive | 1.50 | | | | | | |
| | Index | | | | | | | |
| First | Adhesive | UV1 | UV2 | UV3 | UV3 | UV4 | UV4 | UV4 |
| Adhesive | Thickness | 2.5 | 2.5 | 3.2 | 6.0 | 2.5 | 6.0 | 2.5 |
| | (μm) | | | | | | | |
| | Refractive | 1.51 | 1.51 | 1.51 | 1.51 | 1.54 | 1.54 | 1.56 |
| | Index | | | | | | | |

| | | |
|---|---|---|
| Half-wave | Refractive | 1.58 |
| Retardation | Index | |
| Film | | |
| Second | Type | UV4 |
| Adhesive | Refractive | 1.56 |
| | Index | |
| Quarter- | Refractive | 1.53 |
| wave | Index | |
| Retardation | | |
| Film | | |

TABLE 2

| | | Comparative | Comparative | Comparative |
|---|---|---|---|---|
| | | Example 1 | Example 2 | Example 3 |
| Protective | Type | ZD + HC(29 μm) | | |
| Layer | Refractive | 1.54 | | |
| | Index | | | |
| Polarizer | Type | PVA(13 μm) | | |
| | Refractive | 1.50 | | |
| | Index | | | |
| First | Adhesive | #PSA1 | #PSA1 | #PSA2 |
| Adhesive | Thickness | 5.0 | 5.0 | 25.0 |
| | (μm) | | | |
| | Refractive | 1.47 | 1.47 | 1.47 |
| | Index | | | |

| Half-wave | Refractive | 1.58 | |
|---|---|---|---|
| Retardation Film | Index | | |
| Second | Type | #PSA1 | UV4 |
| Adhesive | Refractive | 1.47 | 1.56 |
| | Index | | |

| | | |
|---|---|---|
| Quarter-wave | Refractive | 1.53 |
| Retardation Film | Index | |

### Types of Adhesives

(1) UV1: Celloxide-2021P (Daisel) 70 parts by weight, 2-ethylhexyl glycidyl ether 30 parts by weight, photopolymerization initiator SP-500 (Adecas) 5 parts by weight, 1,4-diethoxynaphthalene (photosensitizer) 2 parts by weight

(2) UV2: Celloxide-2021P (Daisel) 40 parts by weight, 3-ethyl-3-((vinyloxy)methyl)oxetane 60 parts by weight, photopolymerization initiator SP-500 (Adecas) 5 parts by weight, 1,4-diethoxynaphthalene (photosensitizer) 2 parts by weight

(3) UV3: Celloxide-2021P (Daisel) 35 parts by weight, 2-ethylhexyl glycidyl ether 25 parts by weight, 3-ethyl-3-((vinyloxy) methyl)oxetane 40 parts by weight, photopolymerization initiator SP-500 (ADEKASA) 5 parts by weight, 1,4-diethoxynaphthalene (photosensitizer) 2 parts by weight

(4) UV4: Bisphenol A-type epoxy resin EP-4100E (Adecas) 40 parts by weight, cyclohexyl vinyl ether 30 parts by weight, 3-ethyl-3-((vinyloxy)methyl) oxetane 30 parts by weight, photoinitiator SP-500 (Adecasa) 5 parts by weight, 1,4-diethoxynaphthalene (photosensitizer) 2 parts by weight

(5) UVS: Celloxide-2021P (Daisel) 10 parts by weight, Bisphenol F-type EP-4901E (Adecas) 70 parts by weight, bisphenol-based epoxy resin EX-212L (Nagase Chemtex) 20 parts by weight, photopolymerization initiator SP-500 (ADEKASA) 5 parts by weight, 1,4-diethoxynaphthalene (photosensitizer) 2 parts by weight

(6) #PSA 1: An adhesive layer was formed using an acrylic adhesive of Lintec Corp., containing an acid. Specifically, #L2 (Lintec) adhesive having an adhesion force to UV/alkali glass of 0.2 N/25 mm or more, and being a UV/thermally curing type was used to form the adhesive layer having a thickness of 5 μm and a refractive index of about 1.47.

(7) #PSA 2: An adhesive layer was formed using an acrylic adhesive of Lintec Corp., containing an acid. Specifically, #L7 (Lintec) adhesive having an adhesion force to UV/alkali glass of 0.2 N/25 mm or more, and being a thermally curing type was used to form the adhesive layer having a thickness of 25 μm and a refractive index of about 1.47.

### Experimental Example: Evaluation of Reflection Properties

Front SCI reflectance values of the polarizing laminates of Examples and Comparative Examples were evaluated using an aluminum reflector and CM-2600D equipment from Konica Minolta.

Omnidirectional oblique reflectance values were measured using DMS-803 equipment while fixing an elevation angle at 60° and rotating an azimuth angle by 360°. The results are shown in Table 3 below.

Referring to Table 3 below, the front and oblique reflection were effectively suppressed in Examples.

TABLE 3

| | | Oblique | Change of Oblique |
|---|---|---|---|
| | Front | Reflectance | Reflectance while |
| | Reflectance | SCI | rotating angle |
| | SCI | (ave) | (ΔSCI (max − min)) |
| Example 1 | 5.09 | 7.99 | 0.70 |
| Example 2 | 5.05 | 7.93 | 0.67 |
| Example 3 | 5.05 | 7.93 | 0.65 |
| Example 4 | 5.04 | 7.91 | 0.63 |
| Example 5 | 5.02 | 7.87 | 0.60 |
| Example 6 | 5.02 | 7.86 | 0.59 |
| Example 7 | 4.98 | 7.85 | 0.57 |
| Comparative | 5.24 | 8.13 | 1.04 |
| Example 1 | | | |
| Comparative | 5.16 | 8.00 | 0.72 |
| Example 2 | | | |
| Comparative | 5.13 | 7.98 | 0.69 |
| Example 3 | | | |

What is claimed is:

1. A polarizing laminate, comprising:
a first adhesive layer;
a polarizer disposed on an upper surface of the first adhesive layer, the polarizer having a refractive index smaller than that of the first adhesive layer; and
a first retardation layer disposed on a lower surface of the first adhesive layer, the first retardation layer having a refractive index greater than that of the first adhesive layer.

2. The polarizing laminate of claim 1, wherein the first retardation layer comprises a quarter-wave retardation film or a half-wave retardation film.

3. The polarizing laminate of claim 1, wherein the refractive index of the polarizer is from 1.47 to 1.51.

4. The polarizing laminate of claim 1, wherein the refractive index of the first adhesive layer is from 1.51 to 1.57.

5. The polarizing laminate of claim 1, wherein the refractive index of the first retardation layer is from 1.55 to 1.61.

6. The polarizing laminate of claim 1, further comprising a second retardation layer disposed under the first retardation layer, and a difference of refractive indices between the first retardation layer and the second retardation layer is 0.05 or less.

7. The polarizing laminate of claim 6, further comprising a second adhesive layer disposed between the first retardation layer and the second retardation layer,
wherein a difference of refractive indices between the second adhesive layer and the first retardation layer, and a difference of refractive indices between the second adhesive layer and of the second retardation layer are each 0.05 or less.

8. The polarizing laminate of claim 1, further comprising a lower adhesive layer disposed under the first retardation layer.

9. The polarizing laminate of claim 8, wherein a difference of refractive indices between the lower adhesive layer and the first retardation layer is 0.05 or less.

10. The polarizing laminate of claim 1, further comprising a polarizer protective layer disposed on a top surface of the polarizer.

11. An image display device, comprising:
a display panel; and
the polarizing laminate of claim 1 on the display panel.

12. The image display device of claim 11, further comprising a touch sensor layer disposed on the polarizing laminate or disposed between the display panel and the polarizing laminate.

13. The image display device of claim 11, wherein the image display device is a flexible display.
